(19) United States
(12) Patent Application Publication
(10) Pub. No.: US 2006/0008318 A1
(43) Pub. Date: Jan. 12, 2006

(54) Ring binder mechanism with reinforced hinge plates

(75) Inventor: Wing Yiu Ng, Hong Kong (CN)

Correspondence Address: SENNIGER POWERS, ONE METROPOLITAN SQUARE, 16TH FLOOR, ST LOUIS, MO, 63102, US

(73) Assignee: World Wide Stationery Manufacturing Company Limited

(21) Appl. No.: 10/886,069

(22) Filed: Jul. 7, 2004

(51) Int. Cl. B42F 13/02

(52) U.S. Cl. 402/19

(57) ABSTRACT

A ring binder mechanism for retaining loose-leaf pages comprises an elongate housing that supports two hinge plates for loose pivoting motion. Ring members attach to the hinge plates and move with the pivoting motion of the hinge plates between a closed position and an open position. Levers are pivotally attached to longitudinal ends of the housing for pivoting the hinge plates to move the ring members. The hinge plates define an opening therein, generally adjacent to one of the levers, for receiving a fastener through the hinge plates to attach the mechanism to a cover. Reinforcing structure is provided around the opening for rigidifying the hinge plates in that area and for preventing the hinge plates from bending or deforming near the opening during operation.

### BACKGROUND OF THE INVENTION

This invention relates to a ring binder mechanism for retaining loose-leaf pages, and in particular to an improved mechanism having hinge plates that are reinforced.

As is known in the art, a typical ring binder mechanism retains loose-leaf pages, such as hole-punched papers, in a file or notebook. It generally features multiple rings, each including two half ring members that mount on two adjacent hinge plates. The hinge plates join together about a pivot axis and loosely pivot within an elongate housing, allowing the ring members mounted thereon to move between an open position where papers may be added or removed and a closed position where papers are retained and can move along the rings. An operator may typically open or close the ring members by manually pulling the ring members apart or pushing them together. In addition, in some mechanisms the operator can move levers located at ends of the housing to open or close the ring members. In these mechanisms, the levers often engage the hinge plates and drive them between the open and closed position.

Conventionally, the mechanism is secured to a cover of the file or notebook by a pair of rivets, generally located toward longitudinal ends of the housing. Each rivet attaches to a corresponding eyelet of the housing, spacing the mechanism from the cover and allowing the hinge plates to pivot without contacting the cover. The eyelets provide a surface to receive the rivet so that the rivet does not pull through the housing when the mechanism is secured to the cover. Alternatively, in some mechanisms the eyelets are replaced by barrel bushings or other suitable mounting structure. The barrel bushings are substantially similar to the eyelets, but are generally wider. Eyelets and barrel bushings are described, and further distinguished, in commonly assigned U.S. Pat. No. 5,879,097, the entire disclosure of which is hereby incorporated by reference.

To accommodate the eyelets (or the barrel bushings), the hinge plates usually have openings therein (toward their longitudinal ends) that allow the mounting structure to pass through the hinge plates without interfering with their operation. These openings, however, may weaken the hinge plates near their ends. This is a particular concern in ring binder mechanisms having the wider barrel bushings for receiving the rivets and in mechanisms having a relatively narrow housing. In both mechanisms, the openings generally comprise a substantially large portion of the width of the hinge plates. Accordingly, when these mechanisms use levers located at the ends of the housing to pivot the hinge plates, the driving forces imparted by the levers may cause the ends of the hinge plates to bend rather than pivot about their hinge axis, potentially leaving the hinge plates inoperable.

One solution to this problem is to keep the openings relatively small. But with small openings, the size of the mounting structure must be correspondingly small. Another solution is to construct the hinge plates from larger gauge metal. But this can make fabrication of the hinge plates more difficult and increase the cost of production. Thus, a reinforced hinge plate that resists bending or deforming at its ends would be desirable.

It is generally known in the art to strengthen hinge plates. In particular, it is known to preform the hinge plates with circular indentations around each ring member attachment hole and with linear indentations between consecutive attachment holes. Examples of these strengthened hinge plates are shown in U.S. Pat. Nos. 5,368,407 and 5,378,073. But the indentations of these plates are centrally located along the plates and therefore do not effectively provide reinforcement to ends of the hinge plates, adjacent to both the lever and the mounting structure.

Accordingly, there is still a need for an improved ring binder mechanism having hinge plates that are reinforced so that they do not bend or deform adjacent the lever during operation.

### SUMMARY OF THE INVENTION

The present invention provides an improved ring binder mechanism having hinge plates that are rigidified near the lever for preventing the hinge plates from bending or deforming during operation. In general, a ring binder mechanism of the present invention retains loose-leaf pages. The mechanism comprises an elongate housing and hinge plates supported by the housing for relative pivoting motion. The mechanism also comprises at least one ring, which includes first and second ring members. The first ring member is mounted on one of the hinge plates and moves with the pivoting motion of that hinge plate between a closed position and an open position. In the closed position, the two ring members of the ring form a substantially continuous, closed loop for allowing loose-leaf pages retained by the ring to be moved along the ring from one ring member to the other. In the open position, the two ring members of the ring form a discontinuous, open loop for adding or removing loose-leaf pages from the ring. A lever is mounted on the housing for movement relative to the housing and is adapted for engaging at least one of the hinge plates for moving the ring members from one of the open position and closed position to the other of the open position and closed position. Moreover, at least one of the hinge plates of the mechanism is formed with a reinforcing structure located generally adjacent to the lever for rigidifying the hinge plate adjacent the lever.

Other objects and features of the present invention will be in part apparent and in part pointed out hereinafter.

### BRIEF DESCRIPTION OF THE DRAWINGS

FIG. 1 is a perspective of a notebook incorporating a ring binder mechanism of the present invention;

FIG. 2 is a perspective of the ring binder mechanism of the present invention with ring members at a closed position;

FIG. 3 is an inverted exploded perspective of the mechanism of FIG. 2;

FIG. 4A is an outer longitudinal edge margin side elevation of a hinge plate of the mechanism of FIG. 3;

FIG. 4B is a top plan of the hinge plate of FIG. 4A;

FIG. 5A is an enlarged fragmentary perspective of the hinge plate of FIG. 4B;

FIG. 5B is a section taken on line 5B-5B of FIG. 5A;

FIG. 6 is a perspective similar to FIG. 2 with the mechanism inverted;

FIG. 7 is the perspective of FIG. 6 but with the ring members at an open position;

FIG. 8A is an enlarged fragmentary perspective of the mechanism of FIG. 2 with a housing, barrel bushings, and ring members removed;

FIG. 8B is a section taken on line 8B-8B of FIG. 8A;

FIG. 9 is an enlarged fragmentary perspective of the mechanism of FIG. 6;

FIG. 10 is an inverted section taken on line 10-10 of FIG. 9 but with a rivet and a spine of the notebook also shown;

FIG. 11 is an enlarged fragmentary perspective similar to FIG. 9 with an eyelet attached to the mechanism; and

FIG. 12 is an inverted section taken on line 12-12 of FIG. 11 but with the rivet and the spine also shown.

Corresponding reference characters indicate corresponding parts throughout the several views of the drawings.

### DETAILED DESCRIPTION OF THE INVENTION

This application contains subject matter in common with co-assigned, co-pending design patent application Ser. No. ______ filed simultaneously herewith for A Reinforced Hinge Plate For A Ring Mechanism, the entire disclosure of which is hereby incorporated by reference.

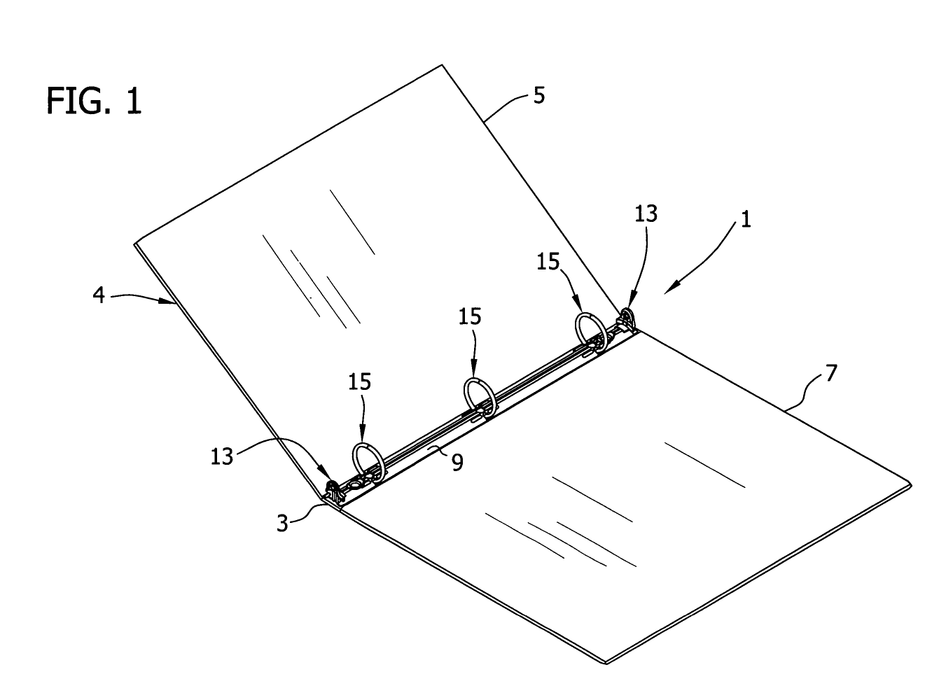

Referring now to the drawings, and particularly to FIG. 1, a ring binder mechanism according to the present invention is designated generally by reference numeral 1. The mechanism 1 is shown mounted on a spine 3 of a notebook 4 having a front cover 5 and a back cover 7 hingedly attached to the spine. The front and back covers 5, 7 are movable to selectively cover or expose pages (not shown) retained by the mechanism 1. Ring binder mechanisms mounted on surfaces other than a notebook, however, do not depart from the scope of the present invention.

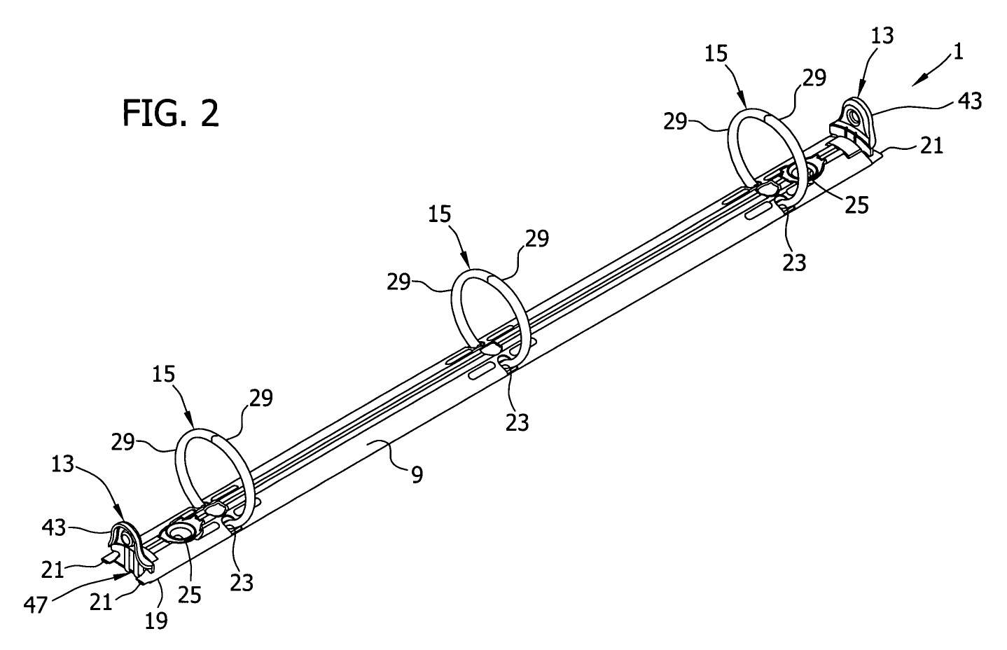

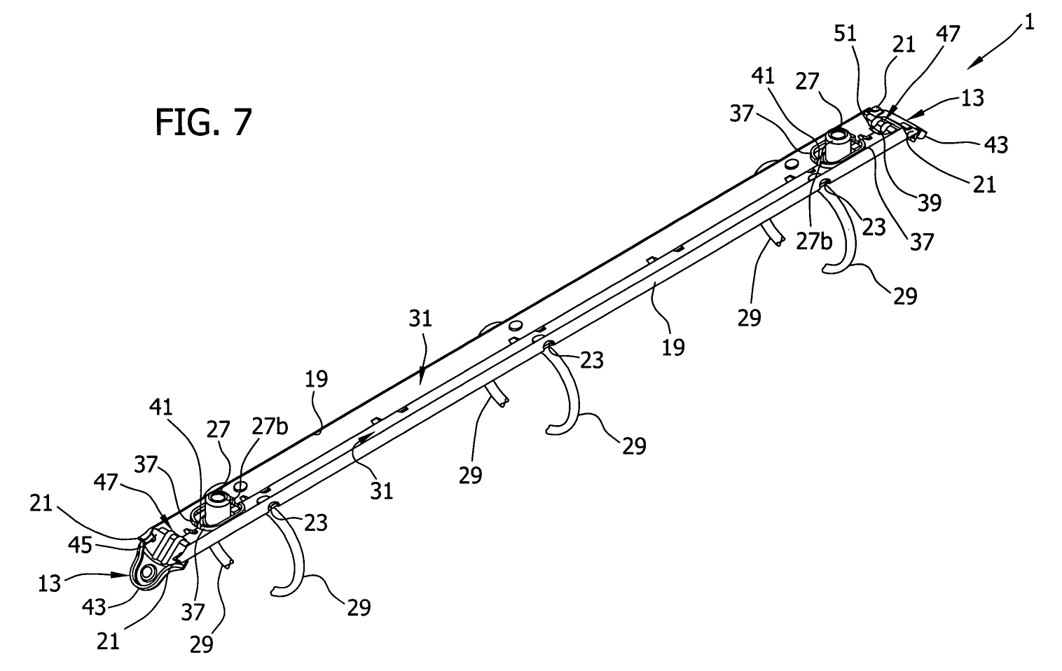

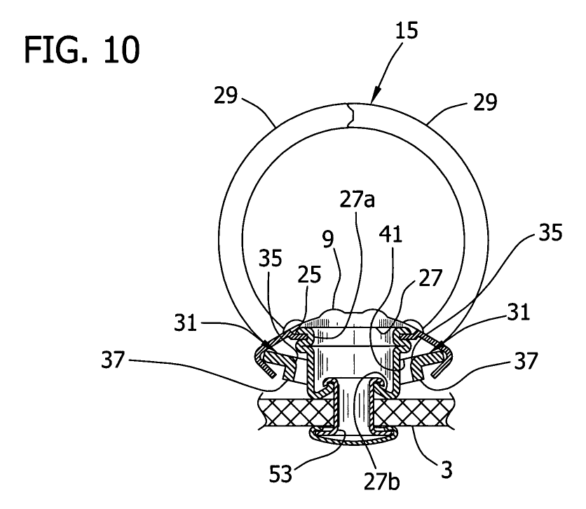

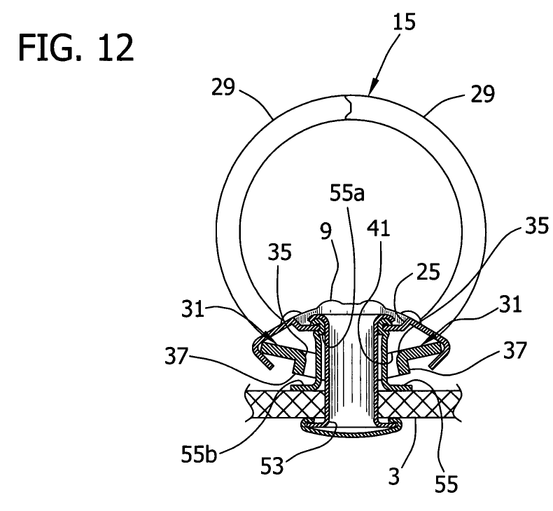

As shown in FIGS. 1 and 2, the ring binder mechanism 1 includes an elongate housing 9 that supports two substantially similar actuating levers (each designated generally by reference numeral 13) and three rings (each designated generally by reference numeral 15). The housing 9 is symmetrical with a roughly arch-shaped cross section (see FIGS. 10 and 12) and includes a longitudinal axis, two transversely opposite longitudinally extending edges, and two longitudinal ends. Each lever 13 pivotally mounts on the housing 9, generally at an opposite longitudinal end, for controlling movement of the rings 15 between a closed position (see FIGS. 1, 2, and 6) and an open position (see FIG. 7).

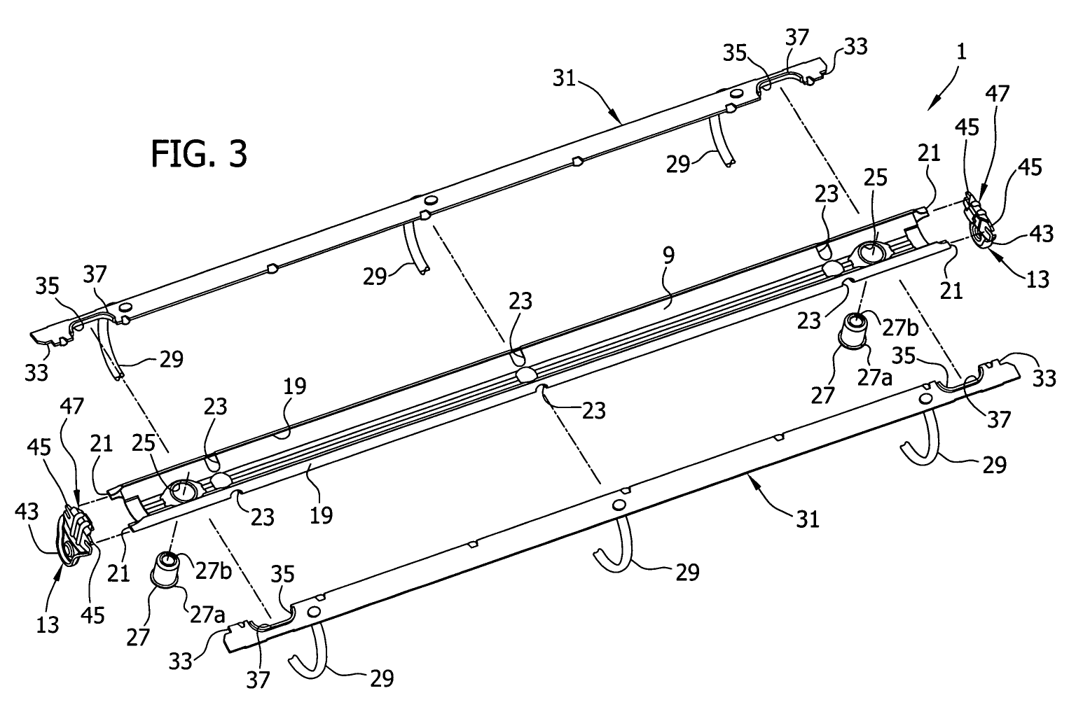

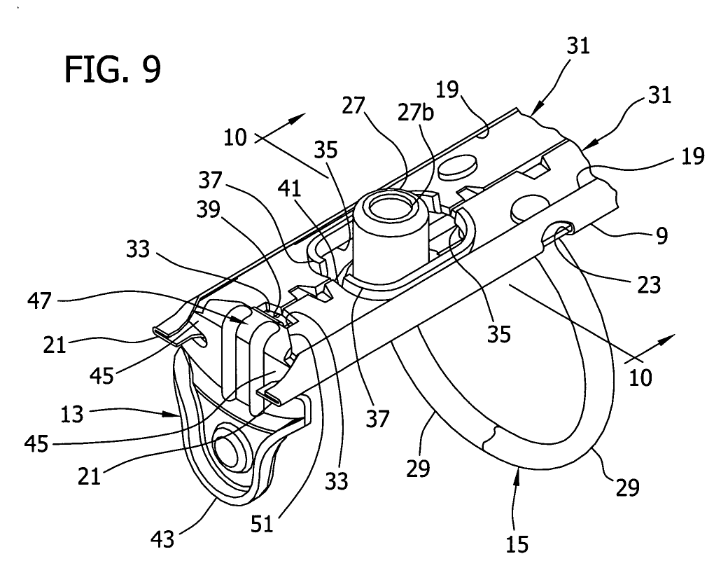

As best shown in FIG. 3, a bent under rim 19 is formed along each longitudinal edge of the housing 9, extending the full length of the housing from one longitudinal end to the other. Each end of the two bent under rims 19 is pinched together with a portion of an upper surface of the housing 9 to form four pockets (each pocket being designated by reference numeral 21). Accordingly, there are two pockets 21 extending longitudinally outward from each longitudinal end of the housing 9. Six total slots 23 are positioned along the two bent under rims 19. The slots 23 are arranged in three transversely opposed pairs with each pair receiving one of the rings 15 therethrough, allowing each ring to move laterally of the housing 9 for opening and closing. Two additional circular openings 25 are provided in the upper surface of the housing 9, near the longitudinal ends, each receiving and attaching mounting structure to the housing 9 (in the mechanism illustrated in FIGS. 1-10, the mounting structure includes two barrel bushings 27), supporting the mechanism 1 above the spine 3 of the notebook. It is envisioned that the housing of the present invention is made of metal, but it may be made of any other suitable material that is sufficiently rigid to provide a stable mount for components of the mechanism. In addition, different shaped housings, including asymmetrical ones, do not depart from the scope of this invention.

Referring now to FIGS. 2, 3, 6, and 7, the rings 15 each include two ring members 29 which are movable relative to one another between a closed position and an open position. In the closed position, the ring members 29 form a substantially continuous, closed, ring or loop for retaining loose-leaf pages and for allowing the pages to move along the rings 15 from one ring member 29 to the other. In the open position, the ring members 29 form a discontinuous, open loop suitable for adding or removing pages. It is envisioned that the ring members are formed of a conventional, cylindrical rod of suitable material, such as steel. But it is understood that ring members having a different cross section or ring members made of different material do not depart from the scope of the present invention. Although in the illustrated mechanism both ring members can move, mechanisms having one movable ring member and one fixed do not depart from the scope of the invention. In addition, mechanisms with more or less than three rings or with rings that form other shapes, such as slanted “D” shapes, when ring members are closed, do not depart from the scope of this invention.

As shown in FIGS. 3-5B, the two ring members 29 of each ring 15 are mounted opposite each other on one of a pair of hinge plates (each hinge plate being designated generally by reference numeral 31). The hinge plates 31 are each thin and elongate, having an inner and an outer longitudinal edge margin and two longitudinal ends. Each hinge plate 31 additionally includes two squared notches 33 and two rounded cutouts 35, each of which are located along the inner longitudinal edge margin of the hinge plate. The two notches 33 are each located at an opposite longitudinal end of the hinge plate 31, and the two cutouts 35 are each located inward from a one of the respective notches 33 but still generally adjacent the hinge plates' ends. The cutouts 35 are each somewhat elongated and have a relatively straight side with two rounded ends. The side is receded into the hinge plate 31 and is roughly parallel to the hinge plate's inner and outer longitudinal edge margins. Reinforcing structure extends substantially around a perimeter of each cutout 35 for reinforcing the hinge plates 31 adjacent the cutouts. In the illustrated mechanism 1, this reinforcing structure is an upstanding rib 37, which will be discussed in more detail hereinafter. Mechanisms having reinforcing structure with a different shape than that described and illustrated herein do not depart from the scope of the present invention.

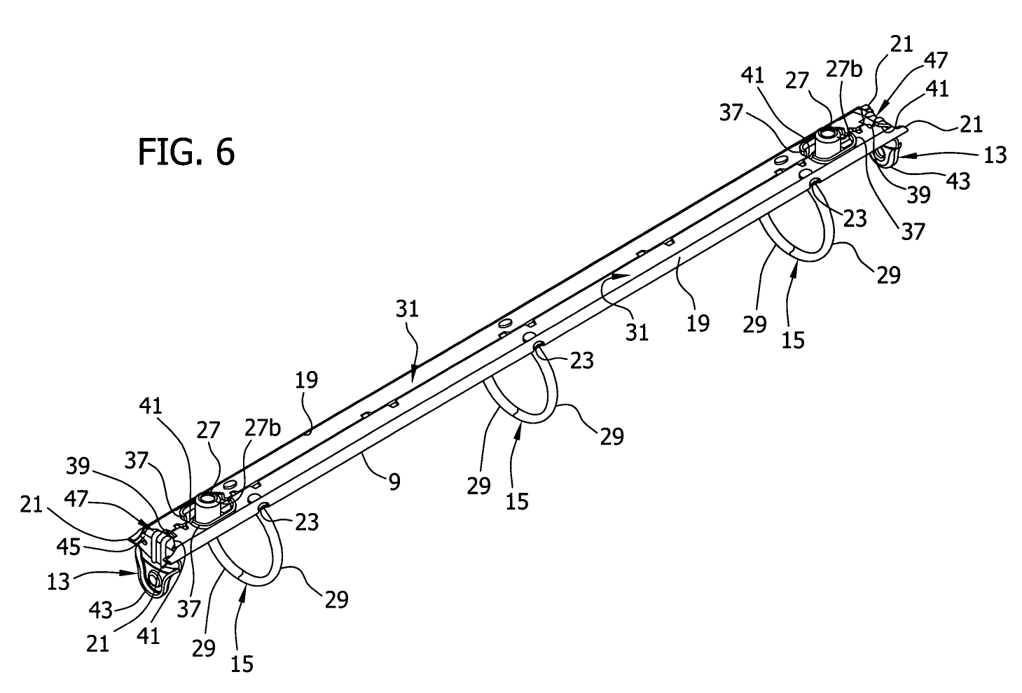

Now referring to FIGS. 6, 7, and 9, the hinge plates 31 attach to one another in parallel arrangement along their inner longitudinal edge margins, forming a central hinge having a pivot axis. The housing 9 loosely receives the outer longitudinal edge margins of the interconnected hinge plates 31 above its two bent under rims 19. Thus, the hinge plates 31 are retained on the housing 9 while the outer longitudinal edge margins are free to move within the rims 19. Corresponding notches 33 of the adjoining hinge plates align to form two box-shaped recesses 39 at opposite longitudinal ends of the plates 31. These recesses 39 are sized and shaped to interact with the actuating levers 13, as will be described in more detail hereinafter. Similarly, corresponding cutouts 35 align to form two roughly oval openings 41, each sized and shaped for receiving one of the barrel bushings 27 through the hinge plates 31. The ribs 37 of each cutout 35 align to substantially extend around a perimeter of each opening 41, rigidifying the interconnected hinge plates adjacent the openings and preventing them from bending during operation. Mechanisms having reinforcing structure that does not substantially encompass an opening do not depart from the scope of the present invention. Furthermore, in the illustrated mechanism 1 the box-shaped recesses 39 and the oval openings 41 are both symmetrically positioned about the pivot axis of the interconnected hinge plates 31. However, mechanisms in which openings and recesses are positioned differently about a pivot axis of interconnected hinge plates do not depart from the scope of the present invention.

In this mechanism 1, the housing 9 is slightly narrower than the joined hinge plates 31 when the hinge plates are in a coplanar position (i.e., an angle between exterior surfaces of the hinge plates is 180°). So as the hinge plates 31 pivot through this position, they deform the resilient housing 9 and cause a spring force in the housing that urges the hinge plates 31 to pivot away from the coplanar position, either closing the ring members 29 (i.e., moving the pivot axis down and away from the housing's upper surface (FIG. 6)) or opening them (i.e., moving the pivot axis up and toward the housing's upper surface (FIG. 7)). Moreover, when the ring members 29 are closed, this spring force resists hinge plate movement and clamps the ring members together. When the ring members 29 are open, the spring force holds them apart.

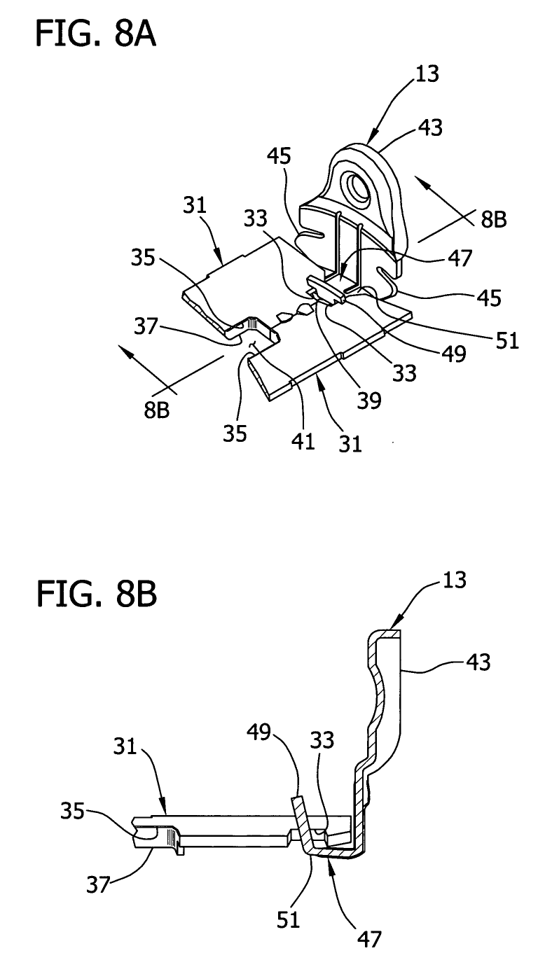

The two actuating levers 13 are generally shown in FIGS. 2, 3, 8A-9, and 11. Each includes a relatively flat head 43 that extends upward from the lever 13, generally above the housing 9, for grasping to pivot the lever. Each additionally includes two lateral arms, each designated by reference numeral 45, and a cam, designated generally by reference numeral 47. As best shown in FIGS. 8A-9 and 11, the lateral arms 45 extend laterally outward from opposite sides of each lever 13 below the flat head 43. The two arms 45 of each lever loosely fit within the two pockets 21 located at each longitudinal end of the housing 9, allowing the levers 13 to pivot within the pockets 21 relative to the housing about an axis transverse to the housing. The cam 47 of each lever is integrally attached to the lever 13 below the lateral arms 45. It extends downward from the arms 45 and curves outward from the flat head 43, fitting into one of the respective box-shaped recesses 39 of the hinge plates. An enlarged tab 49 of each cam fits loosely over the interconnected hinge plates 31 while a base 51 of each cam rests below the plates. Together, the tab 49 and base 51 releasably lock the hinge plates 31 therebetween for operable engagement to control the pivoting motion of the hinge plates that close and open the ring members 29. In operation to close the ring members 29, the levers 13 are pivoted upward and inward. The tabs 49 engage a top surface of the hinge plates 31 and pull the pivot axis of the plates downward. To open the ring members 29, the levers 13 are pivoted outward and downward. The bases 51 engage a bottom surface of the hinge plates 31 and push the pivot axis of the plates upward. Mechanisms (not shown) having levers with different shapes or levers pivotally attached to a housing differently do not depart from the scope of the present invention. In addition, mechanisms having only one lever for driving the hinge plates do not depart from the scope of the present invention.

Referring now to FIGS. 3, 6, 7, 9, and 10, the two barrel bushings 27 are located adjacent the levers 13 and space the ring binder mechanism 1 off the notebook 4 so that the hinge plates 31 can pivot without engaging the spine 3. In this position, the bushings 27 align with the oval openings 41 of the interconnected hinge plates 31 and pass through the hinge plates without interfering with their operation. Each barrel bushing 27 is tubular in shape and has two open ends. At a first end, the barrel bushing 27 includes a deformable lip 27a that attaches the bushing to one of the circular openings 25 in the upper surface of the housing 9. At a second end, the bushing 27 includes a circular rim 27b that is folded inward of the bushing for supporting the bushing on the spine 3. As shown in FIG. 10, rivets 53 pass through each of the barrel bushings 27 (only one of the rivets and barrel bushings is visible) for securing the ring binder mechanism 1 to the notebook 4. One end of each rivet 53 attaches to the folded rim 27b of the barrel bushing, and a second end of each rivet 53 attaches to the notebook's spine 3. Mechanisms secured to a notebook or other surface differently than described and illustrated herein do not depart from the scope of the present invention.

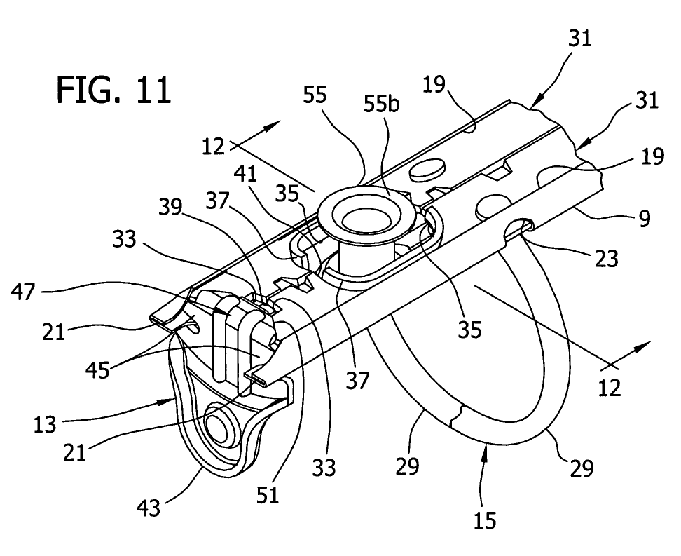

FIGS. 11 and 12 show an alternative construction of the ring binder mechanism 1, which is substantially as described above and illustrated in FIGS. 1-10. But in this construction, the mounting structure includes two eyelets 55 instead of two barrel bushings 27. As with the barrel bushings 27 previously described, each eyelet 55 is located toward a longitudinal end of the housing 9 and passes through one of the oval openings 41 of the hinge plates, allowing the hinge plates 31 to pivot relative to the eyelets 55 without engaging them. Together, the two eyelets support the mechanism 1 above the notebook 4 and prevent the hinge plates 31 from engaging the spine 3 as they pivot. Each eyelet 55 is also tubular in shape and includes two open longitudinal ends. A first end includes a deformable lip 55a for attaching the eyelet 55 to one of the circular openings 25 in the upper surface of the housing 9. A second end includes a circular rim 55b that is folded outward of the eyelet 55 for supporting the eyelet on the spine 3 of the notebook. As shown in FIG. 12, a rivet 53 also passes through each eyelet 55 for securing the mechanism 1 to the notebook 4. But the eyelets are different from the barrel bushings 27 in that they have a smaller diameter. Therefore, the rivets 53 generally attach to the deformable lips 55a of the eyelets when securing the mechanism 1 to the notebook's spine 3.

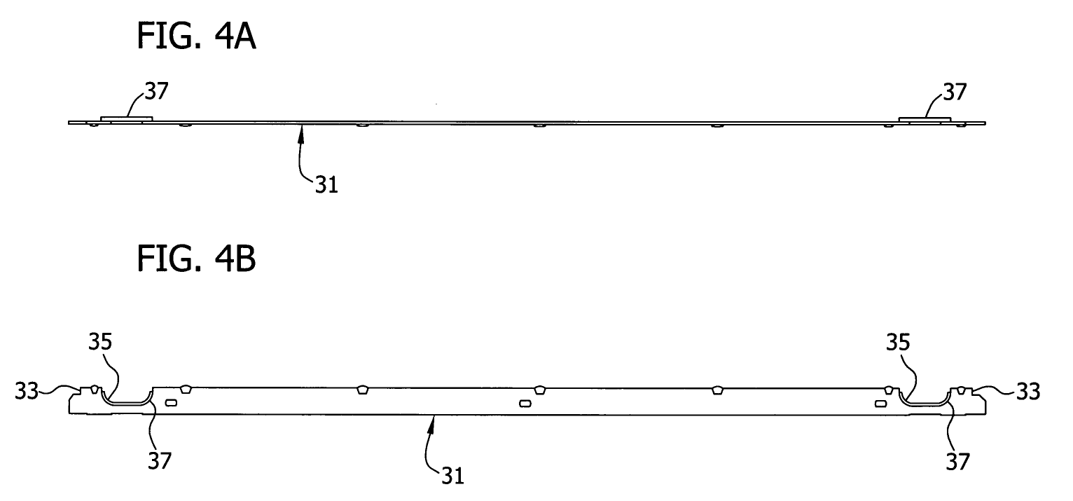

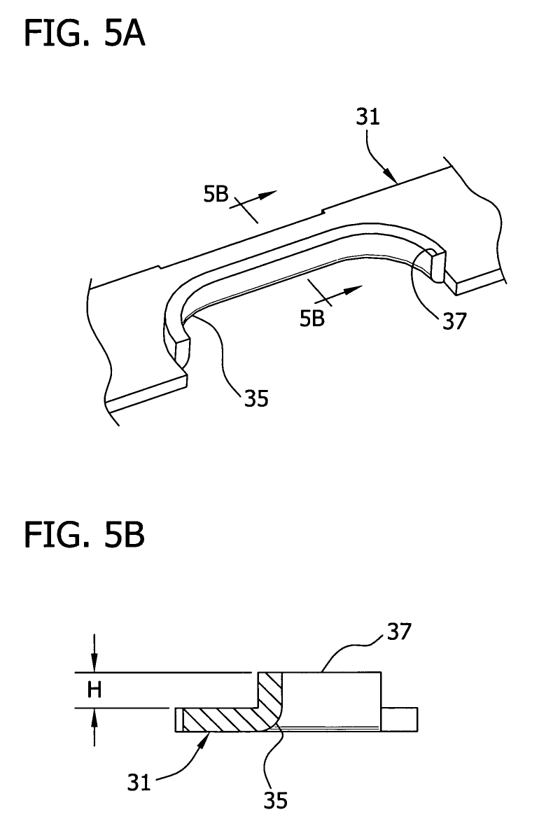

FIGS. 4A-6 illustrate the upstanding ribs 37 of the mechanism 1. As previously described, they substantially encompass each oval opening 41 of the interconnected hinge plates 31. Each rib 37 is preferably formed as one piece with the respective hinge plate 31, and in particular, it is envisioned that each rib 37 is formed by bending the surface of each hinge plate 31 downward, away from the housing 9, approximately 90° so that the rib has a height H that is preferably equal to or greater than the thickness of the hinge plate (FIG. 5B). It is to be understood, however, that mechanisms having ribs or other reinforcing structure formed by bending a surface of a hinge plate upward, toward a housing, or formed separately from a hinge plate do not depart from the scope of the present invention. In addition, mechanisms having ribs with a height that is less than a thickness of a hinge plate do not depart from the scope of the present invention. In the illustrated mechanism 1, the height H of each rib is approximately 0.03 inches (approximately 0.0762 cm), but mechanisms having ribs with heights greater than or less than 0.03 inches (0.0762 cm) do not depart from the scope of the present invention.

As described and illustrated herein, it is to be understood that the upstanding ribs 37 of the present invention provide additional thickness to the hinge plates 31 around the oval openings 41 therein. Accordingly, they effectively reinforce the hinge plates 31 adjacent their longitudinal ends. Thus, in mechanisms having actuating levers located at ends of a housing and mounting structure located adjacent those levers, as in the mechanism 1 described and illustrated herein, the reinforced hinge plates of the present invention would prevent driving forces of the levers from bending or deforming the hinge plates during operation. The reinforced hinge plates reliably pivot about their hinge axis when engaged by the levers.

The reinforced hinge plates are particularly beneficial in mechanisms having barrel bushings (or other mounting structure) mounting the mechanism on a notebook and in mechanisms having narrow housings for mounting on a narrow spine. In both, openings of the hinge plates which accommodate the barrel bushings may comprise a substantially large portion of the width of the hinge plates. This may cause the hinge plates to fail or deflect substantially at the openings during operation. However, the reinforced hinge plates prevent this from happening. They resist the bending forces imparted on the hinge plates when driven by the levers thereby preventing the plates from deforming. A further benefit of these reinforced hinge plates is that they may be constructed of smaller gauge metal because the ribs strengthen the plates at potential weak areas adjacent the openings. Thus, production costs may be lower for ring binder mechanisms incorporating such reinforced hinge plates.

Components of the mechanism of the present invention are made of a suitable rigid material, such as metal (e.g. steel). But mechanisms made of a non-metallic material, specifically including plastic, do not depart from the scope of this invention.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements. Moreover, the use of “up” and “down” and variations thereof is made for convenience, but does not require any particular orientation of the components.

As various changes could be made in the above without departing from the scope of the invention, it is intended that all matter contained in the above description and shown in the accompanying drawings shall be interpreted as illustrative and not in a limiting sense.

What is claimed is:

1. A ring binder mechanism for retaining loose-leaf pages, the mechanism comprising:
an elongate housing;
hinge plates supported by the housing for pivoting motion relative to the housing;
at least one ring including first and second ring members, the first ring member being mounted on one of the hinge plates for movement therewith between a closed position in which the ring members form a substantially continuous, closed loop for allowing loose-leaf pages retained by the ring to be moved along the ring from one ring member to the other, and an open position wherein the ring members of the ring form a discontinuous, open loop for adding or removing loose-leaf pages from the ring;
a lever mounted on the housing for movement relative to the housing and adapted for engagement with at least one of the hinge plates for moving the ring members from one of the open position and the closed position to the other of the open position and the closed position; and
at least one of the hinge plates being formed with reinforcing structure generally adjacent to the lever for rigidifying the at least one hinge plate adjacent to the lever.

2. A ring binder mechanism as set forth in claim 1 wherein the hinge plates define an opening for receiving a fastener through the hinge plates to attach the housing to a cover.

3. A ring binder mechanism as set forth in claim 2 in combination with the fastener.

4. A ring binder mechanism as set forth in claim 2 wherein the reinforcing structure is located at the opening.

5. A ring binder mechanism as set forth in claim 4 wherein the reinforcing structure comprises a rib extending along a perimeter of the opening.

6. A ring binder mechanism as set forth in claim 5 wherein the rib is formed as one piece with said at least one hinge plate.

7. A ring binder mechanism as set forth in claim 5 wherein a height of the rib is equal to or greater than a thickness of the at least one hinge plate on which said rib is formed.

8. A ring binder mechanism as set froth in claim 5 wherein a height of the rib is between about 0.01 inches (about 0.0254 cm) and about 0.10 inches (about 0.254 cm).

9. A ring binder mechanism as set forth in claim 8 wherein the height of the rib is about 0.03 inches (about 0.0762 cm).

10. A ring binder mechanism as set forth in claim 4 wherein a pivot axis of the hinge plates extends through the opening.

11. A ring binder mechanism as set forth in claim 10 wherein the hinge plates define a second opening for receiving a second fastener through the hinge plates to attach the housing to the cover.

12. A ring binder mechanism as set forth in claim 1 comprising a second lever mounted on the housing for movement relative to the housing and adapted for engagement with at least one of the hinge plates, said at least one hinge plate being formed with reinforcing structure generally adjacent to the 5 second lever for rigidifying the at least one hinge plate adjacent to the second lever.

13. A ring binder mechanism as set forth in claim 12 wherein the two levers are pivotally mounted on the housing at opposite longitudinal ends of the housing.

14. A ring binder mechanism as set forth in claim 13 wherein the hinge plates define two openings for receiving fasteners through the hinge plates to attach the housing to a cover, a first opening being adjacent to a first lever and a second opening being adjacent the second lever.

15. A ring binder mechanism as set forth in claim 3 wherein the fastener is a barrel bushing.

16. A ring binder mechanism as set forth in claim 3 wherein the fastener is an eyelet.

17. A ring binder mechanism as set forth in claim 1 in combination with a cover, the ring binder mechanism being mounted on the cover, the cover being hinged for movement to selectively cover and expose loose-leaf pages retained on the ring binder mechanism.
